(19) United States
(12) Patent Application Publication
(10) Pub. No.: US 2024/0412599 A1
(43) Pub. Date: Dec. 12, 2024

(54) SUPER SYMBOLS

(71) Applicant: RAW IGAMING LTD., Pieta (MT)

(72) Inventors: Thomas Wood, Kalmar (SE); Alec Horley, Bognor Regis (GB); Nicolas Pavelek, Buenos Aires (AR)

(21) Appl. No.: 18/736,416

(22) Filed: Jun. 6, 2024

Related U.S. Application Data
(60) Provisional application No. 63/471,729, filed on Jun. 7, 2023.

(51) Int. Cl. G07F 17/32

(52) U.S. Cl. CPC G07F 17/3267; G07F 17/3211

(57) ABSTRACT

Systems and methods for online gaming are provided. The systems and methods may include receiving a request, validating a bet and allocating a stake, initiating game logic to define the game's progress and outcomes, loading an initial game grid and randomly positioning symbols within the grid, identifying clusters of symbols and merging them into enhanced symbols, applying modifiers, to the identified enhanced symbols to increase their payout value, communicating the result of the game round to the client, displaying the final arrangement of symbols and any resulting enhanced symbols or clusters to the player, determining when an enhanced symbol forms or grows and notifying the server that the client is ready for the next cascade, clearing the grid of non-contributing symbols and cascading in new symbols to form additional clusters and enhanced symbols, awarding final pays when no new enhanced symbols form or grow, and completing the game round.

### CROSS-REFERENCE TO RELATED APPLICATIONS

The present application claims priority to U.S. Provisional Application No. 63/471,729, entitled “SUPER SYMBOLS,” filed on Jun. 7, 2023, which is expressly incorporated by reference herein in its entirety.

### TECHNICAL FIELD

The disclosure relates generally to the field of gaming, and specifically and not by way of limitation, some embodiments are related to online casino gaming.

### BACKGROUND

### The Sea of Sameness

In online casino gaming today, between 200-250 new online Casino games are released each month. That is around 7-9 games per day going live which neither operator nor players can consume.

A significant portion, e.g., 85-90% of these new online Casino games look the same and have the same features as other online Casino games. This underlines the commoditization of Casino games and online gaming lobbies have started to look like grocery store shelves where positioning and rebates/offers drive public consumption. With increasing regulation, rebates and offers are becoming a thing of the past, so it is beleved that in the near future, innovation and differentiation will drive operator and public consumption. This even extends to land-based gaming where a casino floor looks like a sea of buffalos, leprechauns, and Egyptian games with similar game play, sounds, and mechanics.

### Simplifying the Player Experience

The other 10-15% of studios who do try to innovate still take a standard approach to games but attempt to create more differentiation through adding more symbols, bigger-sized games, more winning lines, and combinations which creates more and more complex games that players can find hard to follow and understand, especially if you are new to iGaming.

When experiencing the games on smaller mobile interfaces, the gaming experience becomes harder to see or follow and players can become confused as to why they won or lost. Some games offer up to 1-2 million winning lines. These many lines may be impossible to visually represent and difficult for the player to follow. Some games can grow from 3×5 (columns and rows) to 10×16, creating a huge array of symbols, win lines, and animations. While the presentation is exciting, the presentation also complicates the view for players and makes the game hard to understand and follow what is causing the win or miss.

Accordingly, a need exists for an improved way of creating exciting new experiences for players through simplified gameplay so players can easily follow the game and understand game payouts and win opportunities.

### SUMMARY

The method includes receiving a request to initiate a round of the game, validating a bet and allocating a stake for the bet, initiating game logic to define the game's progress and outcomes based on player inputs and predefined rules, loading an initial game grid and randomly positioning symbols within the grid, identifying clusters of symbols and merging them into enhanced symbols, applying modifiers, including multipliers, to the identified enhanced symbols to increase their payout value, communicating the result of the game round to the client, displaying the final arrangement of symbols and any resulting enhanced symbols or clusters to the player, determining when an enhanced symbol forms or grows and notifying the server that the client is ready for the next cascade, clearing the grid of non-contributing symbols and cascading in new symbols to form additional clusters and enhanced symbols, awarding final pays when no new enhanced symbols form or grow, and completing the game round.

The system includes a server to receive requests and initiate game logic, an operator system to validate bets and allocate stakes, a game grid module to load and position symbols, a cluster identification module to merge symbols into enhanced symbols, a modifier application module to apply modifiers to enhance payout values, a communication module to relay game results to the client, a display module to show the final arrangement of symbols, a cascade control module to handle symbol cascades, and a payout module to award final pays. The system facilitates the described game mechanics through its various interconnected modules.

The non-transitory computer-readable media includes instructions for receiving requests to initiate a round of the game, validating bets and allocating stakes, initiating game logic, loading and positioning symbols within the game grid, identifying and merging symbol clusters into enhanced symbols, applying modifiers to increase payout values, communicating game results to the client, displaying the final arrangement of symbols and clusters, determining when enhanced symbols form or grow, notifying the server for the next cascade, clearing non-contributing symbols and cascading new symbols, awarding final pays, and completing the game round. When executed by a processor, these instructions enable the performance of the described methods.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIGS. 1A-1B is a flowchart illustrating an example of the systems and methods.

FIG. 2 is a diagram that illustrates a system for conducting an online casino game, designed to enhance player experience through innovative game mechanics.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Embodiments of the systems, methods, and devices described herein may have one or more of the following capabilities. For example, one embodiment of the systems, methods, and devices described herein may include one or more parts made from one or more structural steel supports, steel supports, aluminum supports, metal supports, plastic supports, or any other support that may be appropriate to implement the devices described herein.

### Increase the Exposure of Well-Known Branded Content

Most Casino games that utilize third party global brands, do not provide, or do not have the ability to utilize a brand's images and likeness in a way that truly captures a brand's essence. This may be because studios may be stuck in the same “template” as every other slot provider due to the lack of innovation or interest in finding ways to better present the brand imagery. This may be also because a standard 3×5 or 4×5 slot appears much smaller in a mobile device, which may often be played in portrait mode. In fact, in some markets, portrait mobile play is reaching the levels of 80% of the entire gameplay. That means studios should be taking seriously the experience players have in this format.

In some embodiments, “enhanced symbols,” such as SuperSymbols™ achieve this by creating a direct connection to the brand's imagery but in a larger format where the essence of the gameplay and winning opportunities may be directly connected to the brand imagery and the brand's growth in the game, creating a strong relationship between the positivity of winning and the brand itself.

Studios are calling minor adjustments in math features or game art enhancements as innovations, however the experience for the player may still be the same as before. Very few have created new innovations that break outside of the normal templates of traditional slot mechanics and are still focused on traditional slot players. Studios are open about copying their competitors game styles and mechanics which comes down to “if it works for them it should work for us . . . ” but leaves operators with less differentiation in their offering and players with very similar gaming experiences and no focus on new and evolving player bases.

### The Sea of Sameness/Creating a New Pay Format

Differentiation and innovation are seldom seen as studios either do not have the creativity to come with something new, are not willing to take the risk to innovate, do not see the value in innovation or do not have the financial backing to allow for it.

RAW iGaming aims to solve this issue by presenting operators and players with unique new math mechanics and game presentation that offer new and exciting experiences which cut through the “Sea of Sameness.” This gives operators something new to market and differentiate themselves against others. Each math engine or game product RAW creates, brings a new way of playing Casino games as well as a new way in which Casino games introduce a game round.

In some embodiments, the enhanced symbols game engine presents a new family of gameplay where a winning round may be represented based on the pixel count of a symbol rather than whether symbols appear in a line, clumps, or across ways. Typically, slot games pay a win based on one of six forms of payment: the use of lines, where any number of the same symbols end up on a predetermined pay line starting from the left and award a payment depending upon the symbol value and the number of symbols in that line. The use of anyway pays, which ignores lines and awards a pay as long as the same symbol appears from the left in any position on a reel set column. The use of both ways lines or anyway pays, where any number of the same symbols end up on a predetermined pay line or anyway pays no line pay starting from either left or right and award a payment depending upon the symbol value and the number of symbols in that line. The use of cluster pays, where a cluster of the same symbols of at least five may be connected to each other in any given location or shape on the reel set after the completion of a spin. The use of connecting pays, where any same symbols may be in a line of at least three same symbols in any given location on the reel set after the completion of a spin. The use of scatter pays, where at least two predetermined special scatter symbols appear in any position on the reels during the completion of a spin. Enhanced symbols (in some embodiments) instead pay based on the pixel count of a symbol as the game “hits” (e.g., a winning gameplay) and grows within the game. The larger the image and pixel count, the greater the results of that play of the game pays the player. Pays can be independent of direction as the pay may only be tied to the pixel size of the image in some embodiments, which opens the door for very interesting mechanics and imagery. This creates a more recognizable, familiar, and simpler game form that delivers an entirely new, unseen game presentation and experience that may be very differentiated in the “Sea of Sameness.” This is true online as in land-based where the games look similar and enhanced symbols would stand out as unique, offer a new presentation layer as well as a new mathematical experience essentially removing the need for advanced and sometimes confusing paying methods. The idea of symbol value connected to the pixel count of a symbol across the reel set, over one spin, a series of spins, or cascades for payment independent upon how that symbol expands or how that pixel count is achieved may be incorporated into some embodiments of the systems, methods, and devices described herein.

The fact that adjacent images, in direct contact with the image, can merge to create a larger pixel count, and hence a greater pay for the player may be incorporated into some embodiments of the systems, methods, and devices described herein. After each cascade, if an adjacent image is the same as the original clumped image, then they merge to create a larger image and trigger a new cascade. Each spin or cascade removes the losing symbols that do not pay and holds the winning image in an attempt to grow the image further on the consecutive spin or cascade. This approach may be incorporated into some embodiments of the systems, methods, and devices described herein. A “hold and re-spin” mechanic may already have a similar outcome, but the growth of the value in that case, is connected to the number of symbols and a value that might be represented on each separate symbol, while in some embodiments, enhanced symbols may have a direct connection to the size of a specific image or symbol and the symbol's pixel count.

Some embodiments addresses several technical challenges inherent in the operation and scalability of online gaming platforms. One issue may be server load and latency experienced during peak usage times. Some example algorithms for symbol placement and clustering may ensure that game rounds are processed efficiently, thereby reducing the computational burden on the server. This technical solution may improve the overall performance and reliability of the gaming system, ensuring a smoother and more responsive gaming experience for users.

Additionally, some embodiments may enhance the fairness of game outcomes by employing advanced randomization techniques that prevent predictable patterns. The system may continuously monitor and adjusts the symbol placement algorithm to maintain randomness and fairness. This approach might not only increases the integrity of the game but also may address potential concerns regarding the predictability and manipulation of game outcomes.

Some example methods for clearing non-contributing symbols and cascading in new symbols may be specifically designed to minimize computational overhead. By efficiently managing the game grid and symbol interactions, the system reduces the processing power required for each game round. These technical innovation may enable example systems to handle a high volume of simultaneous game sessions without performance degradation, making such systems scalable and robust.

In some example embodiments, the system may utilizes a clustering algorithm that dynamically adjusts the threshold for symbol merging based on real-time game data. This clustering algorithm may significantly reduce computational complexity, allowing for faster processing times and a smoother gaming experience. The symbol clustering and merging process may be optimized to detect and merge symbols in a highly efficient manner, leveraging data structures that minimize the number of operations required.

Furthermore, the modifier application process may be designed to avoid redundant calculations, ensuring that multipliers and other modifiers can be applied swiftly and accurately. In some example embodiments, the system may employ a streamlined approach to apply modifiers, which may reduce the time and resources needed for these calculations. This optimization may enhance the overall performance of the game, providing a more engaging and rewarding experience for players.

The advanced randomization techniques used in some example embodiments of the game logic may provide for maintaining unpredictability and fairness in game outcomes. These randomization techniques may help ensure that each game round is unique and free from patterns that could be exploited. By integrating these algorithms into the core game mechanics, in some embodiments, the system may achieve a higher level of fairness and player satisfaction.

In some example embodiments, the server architecture may be designed to handle high volumes of simultaneous game sessions, employing a scalable, distributed architecture. Each server node may be equipped with specialized hardware accelerators, such as graphics processing units (GPUs) and/or field-programmable gate arrays (FPGAs), which may improve the efficiency of graphical computations and symbol processing. This hardware setup may enhance the system's ability to render complex graphics and manage intensive computations efficiently.

In some example embodiments, the network infrastructure incorporates advanced load balancing techniques to distribute the game sessions evenly across multiple servers. Advanced load balancing techniques may ensure consistent performance and high availability, preventing bottlenecks and downtime during peak usage periods. The load balancing mechanism may dynamically adjusts to changing demands, maintaining optimal performance and reliability.

In some example embodiments, this setup not only improves the scalability of the system but also enhances its reliability, providing a seamless gaming experience for players. The combination of specialized hardware and advanced network management techniques may ensure that the system may support a large number of concurrent users while delivering high-quality graphics and responsive gameplay.

In some example embodiments, by implementing these technical improvements, the system may achieve a significant reduction in game latency, enhancing the player's experience. The optimized algorithms and efficient data processing may result in quicker response times and more accurate game outcomes. This technical effect may provide for maintaining a high level of player engagement and satisfaction, as the technical effect may help ensure that the game operates smoothly and without noticeable delays.

In some example embodiments, the advanced graphics rendering techniques employed by the system may provide a visually engaging experience, making the game more attractive and enjoyable for players. The system's ability to render high-quality graphics in real-time may enhance the immersive nature of the game, drawing players into the gaming environment. This visual appeal may be complemented by the efficient processing of game mechanics, which keeps the gameplay fluid and dynamic.

In some example embodiments, the system's ability to dynamically adjust game mechanics based on real-time data further may ensure a fair and unpredictable gaming environment. This adaptability may provide for maintaining player trust, as the adaptability may demonstrate that the game is not subject to manipulation or predictable patterns. The technical improvements outlined in some embodiments may contribute to a more reliable and enjoyable gaming experience for players, addressing key challenges in the online gaming industry.

In some example embodiments, the game data may be managed using a distributed database system that ensures data integrity and availability. This distributed approach may allow for horizontal scaling, where additional database nodes may be added to handle increased loads without affecting performance. The system may employ advanced caching mechanisms to speed up data retrieval, reducing latency and improving the overall responsiveness of the game.

In some example embodiments, these caches may be strategically placed to store frequently accessed data, minimizing the need for repeated database queries. By reducing the frequency of database access, the system decreases the load on database servers, ensuring that they may operate efficiently even during peak usage times. This caching strategy may provide for maintaining the high performance and responsiveness of the gaming system.

In some example embodiments, security measures, including encryption and access controls, may be implemented to protect player data and ensure compliance with regulatory requirements. The system may use robust encryption methods to safeguard data during transmission and storage, preventing unauthorized access and ensuring data privacy. Access controls may be enforced to restrict data access to authorized personnel only, further enhancing the security and integrity of player information.

### Simplifying the Player Experience

In some embodiments, the enhanced symbols mechanic presents the game as an empty reel set, and all symbols appear through an initial cascade. If a clump of a minimum 2×2 connecting symbols appear after the cascade (which merge into one symbol), or a symbol of defined pixel count represents a merged image, then a payment may be made or banked based on the pixel count of that symbol (for the player the pixel count of that symbol may be visually referenced against image size). This may make it extremely easy to follow the game as all the player needs to pay attention to is the symbol, the symbol's size and what might connect or clump to the symbol during a spinning or cascading session versus several rows and columns of what can be confusing pays based on a series of symbol lines, connecting pays, anyways or both ways payments. Traditional symbol payments could be represented in a multitude of symbol combinations and when games present 10-15 rows or a large number of ways combinations it becomes hard to follow for the player on what and how they won.

In some embodiments, SuperSymbol™ presents all the possible winning combinations only based on the symbol's pixel count (size), and the symbol's growth in pixels keeping the game very simple for the player to understand pays and to follow the gameplay.

### Increase the Exposure of Well-Known Branded Content

Other studios provide games in a traditional 3×5 or 4×5 format when working with brands, which can limit the size of the imagery (due to the small screen size utilized on mobile phones), which may often be the key element to strengthen brand awareness and stimulate the player regarding the brand.

In some embodiments, with enhanced symbols the image itself may be the key game element and larger images with greater pixel count represent larger rewards so there may be a stronger correlation between the brand and the brand's value for the player. As each cascade happens, players hope for new branded images will drop adjacent to the active, image, and in that case growing the branded image larger, creating more value. This also creates a positive expectation for the brand where players look and root for the brand on each cascade.

The only alternative approach is to present the visual art result of the mathematical outcome in the game as clumped symbols in a cluster game and merge them into one image or as a possible re-spin mechanic where each re-spin, if a similar image lands adjacent to an existing clump, would merge with the clump and trigger another re-spin.

However, cluster games do not utilize pixel count as the pay method but rather the number of single symbols, e.g., typically 5 or more symbols and usually do not merge to create a larger symbol as that would be confusing to the pay method. The value may be connected to the number of symbols and not the count or size of the symbol. There are also no games where adjacent symbols with the same image constitute a growth of an image, increasing its pixel size.

Cluster games also typically explode the winning cluster and cascade to hopefully create a new cluster. In some embodiments, in enhanced symbols, the winning image remains and instead the losing symbols explode to give the player the opportunity to grow their win instead.

The math and presentation could be used in any game format. This includes games for lottery, social games, board games that utilize a digital interface, digitally presented land based Casino, Online or land-based Live presented games, land-based Casino hardware representation, bonusing and gamification features, jackpot awards, basically anything utilizing a digital interface which wishes to present a track combination that allows a symbol or game piece to move and award results based on a dynamic randomly generated result.

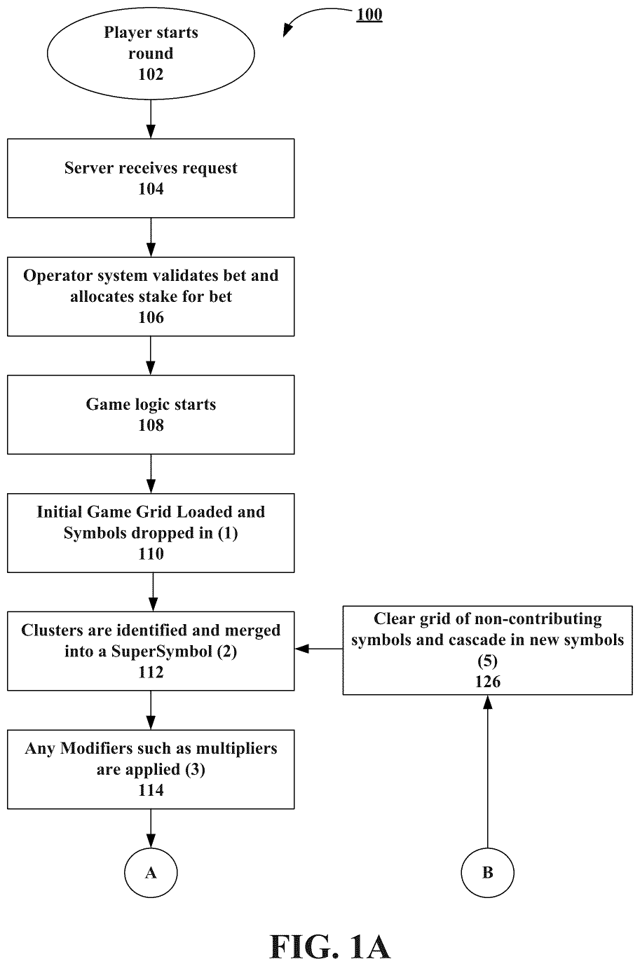

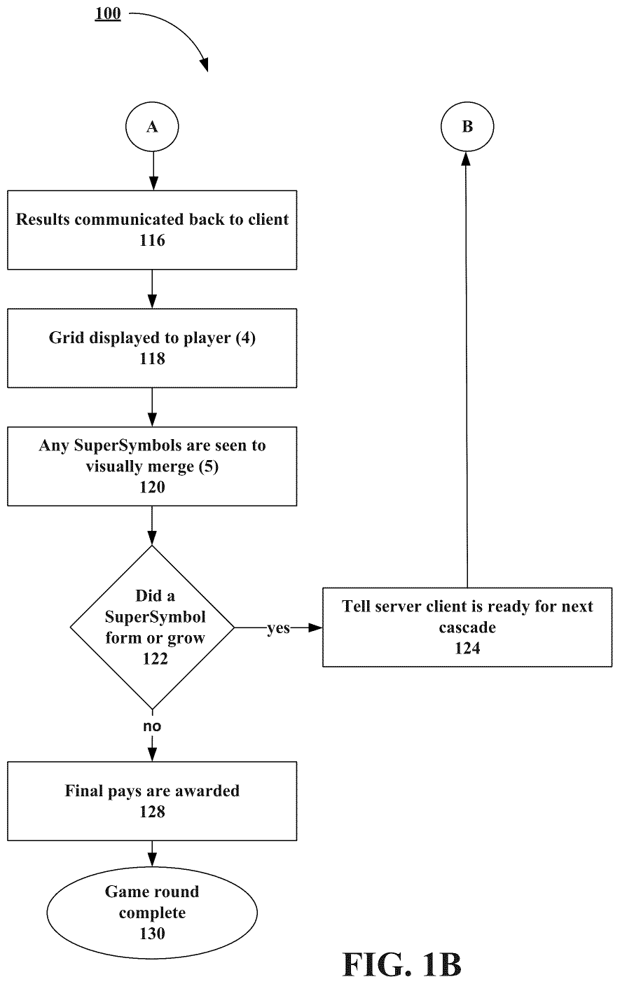

FIGS. 1A-1B is a flowchart 100 illustrating an example of the systems and methods. The method may be performed by a desktop personal computer (PC), a laptop, a betting terminal, a tablet device, a mobile device, a virtual reality (VR), an augmented reality (AR) device, or other electronic devices. The steps are not necessarily illustrated in chronological order and any of the various steps may be optional.

At 102, a player may start a round of the game, which in this context may refer to an online casino game or other gaming experience. The initiation of the game round involves the player engaging with the game interface, making selections, and confirming their intent to participate in a new game session. This could include actions such as placing a bet, selecting game options, or simply pressing a “start” button.

At 104, a server may receive a request related to initiating a round of the game, processing a player's input, and/or handling data necessary for the game. This request may include information about the player's bet, chosen game parameters, and other relevant data. The server processes this request to ensure all necessary information is correctly received and prepares the game for the next steps, which may involve verifying player credentials and ensuring system readiness.

At 106, an operator system may validate a bet and allocate a stake for the bet. This involves ensuring the bet meets any necessary criteria, such as minimum and maximum bet limits, and confirming the player's eligibility to place the bet. The system then allocates the stake, which involves setting aside the bet amount in the player's account and preparing the system to process the bet in accordance with the game's rules and mechanics. This step ensures that funds are available and rules are adhered to before the game begins.

At 108, the game logic starts, initiating the sequence of actions and calculations that define the game's progress and outcomes based on the player's inputs and predefined rules. This involves executing the core game mechanics, such as spinning reels, drawing cards, or triggering animations, depending on the type of game being played. The game logic ensures that the game proceeds smoothly and fairly according to its design, and also handles random number generation and outcome determination.

At 110, an initial game grid may be loaded and symbols may be dropped in, starting the game with a visually engaging display where the symbols are randomly positioned within the grid to set up the initial state of the game. This grid serves as the playing field for the game, and the placement of symbols is critical for determining potential winning combinations and interactions. The symbols are typically dropped into the grid from above, creating a random and unpredictable initial layout.

At 112, clusters may be identified and merged into an enhanced symbol, which increases in value and visual prominence. This process involves detecting groups of matching symbols and combining them into a larger, more valuable symbol. The enhanced symbol often has special properties or higher payout potential, creating a more engaging and rewarding experience for the player. The identification and merging process is continuous and dynamic, allowing for real-time updates during gameplay.

At 114, any modifiers, such as multipliers that increase the payout value, may be applied to the identified enhanced symbols. These modifiers enhance the potential rewards for the player, adding an extra layer of excitement and unpredictability to the game. The application of modifiers is typically based on predefined game rules and can significantly impact the outcome of the game round. Modifiers can include features like bonus multipliers, extra spins, or special symbol interactions.

At 116, a result may be communicated back to the client, informing the player of the outcome of the game round and any winnings or losses. This communication ensures that the player is aware of what has happened during the game round, providing immediate feedback on their performance and the game results. The result communication typically includes a detailed breakdown of winnings, any bonuses awarded, and the player's new balance.

At 118, a grid may be displayed to the player, showing the final arrangement of symbols and any resulting enhanced symbols or clusters. This visual representation helps the player understand the results of the game round, including any new or remaining enhanced symbols that may affect future gameplay. The grid display is updated in real-time, providing a clear and interactive view of the game state.

At 120, any enhanced symbol may be seen to visually merge on the display, creating a larger combined symbol with enhanced visual effects. This merging process is part of the game's dynamic visual presentation, making the game more immersive and visually appealing to the player. The visual effects associated with merging symbols can include animations, sound effects, and other graphical enhancements to highlight significant gameplay events.

At 122, the system determines when an enhanced symbol forms or grows. This involves continuously monitoring the game grid to identify any new or expanding enhanced symbols that may occur as a result of symbol interactions or game mechanics. The determination process includes checking for specific conditions that trigger the formation or growth of enhanced symbols, such as matching clusters or special symbol combinations.

At 124, when an enhanced symbol forms or grows, the system may notify the server that the client is ready for the next cascade. This notification ensures that the server is aware of the game's current state and can prepare for the next sequence of actions, such as dropping in new symbols or triggering additional game features. The server uses this information to synchronize game events and maintain a seamless gameplay experience.

At 126, the system clears the grid of non-contributing symbols and cascades in new symbols, then returns to 112 to identify and merge new clusters. This process involves removing symbols that do not contribute to winning combinations and introducing new symbols into the grid, creating opportunities for new interactions and enhanced symbols. The cascading process is designed to refresh the game grid and keep the gameplay dynamic and engaging.

At 128, when an enhanced symbol does not form or grow, the system may award the final pays. This marks the end of the game round, where any remaining payouts are calculated and awarded to the player based on the final state of the game grid and the rules of the game. The final pay calculation includes summing up all winning combinations and applying any relevant modifiers or bonuses.

At 130, the game round may be complete, concluding the sequence of actions and preparing the system for the next round or allowing the player to exit the game. This final step ensures that all necessary game processes have been completed and the player is informed of their overall results. The system resets and readies itself for the next game round, maintaining a continuous and fluid gaming experience for the player. In some embodiments, the game grid may be the “world” within which enhanced symbols may form (in some embodiments). In some embodiments, the game may comprise of a grid of a defined size into which symbols may be dropped in the hope of forming enhanced symbols.

Clusters of Symbols may be identified from the grid and may be merged.

In some embodiments, if the game is running modifiers, such as multipliers, these may be calculated and applied to the enhanced symbols.

In some embodiments, the player will have the grid revealed to them within the game client. This will display a cascading grid into which the symbols will fall.

In some embodiments, if any enhanced symbols formed from the initial drop, or enlarge from a cascade, this may be displayed within the client and the player may be advised of the update.

In some embodiments, the game ends when a SuperSymbol™ does not form, or no existing SuperSymbol expands.

In some embodiments, selections of results can come in multiple ways, some options include one or more of:

### Reels Based

The rows of the grid may be represented as reels. These will have symbols in groups to allow a chance of forming enhanced symbols. Reels based layouts will usually have a finite length.

### Bias Based

The grid can be generated via random selection of the individual symbols based on weights assigned to each particular symbol type. This then can be used to create layouts that can be infinite in length.

### Final Layout Based

The final result of the game could be defined using biases. e.g. we want 2 super symbols, with specific symbols and specific sizes. Then an algorithm would be used to back-step through a sequence that would arrive at that result.

### Scenario Based

Another option may be to use a scenario-based approach, where the actual result to be played may be pre-stored in a large variety of options. A particular pays scenario may then be selected and applied to the grid. Pre-created scenarios could be combined for different results to be more varied and have good control over the final outcome. Note that although the initial drop-in may come from one of the above, the subsequent cascades can be calculated independently through any of the other options. The only exception here may be the Final Layout based approach.

### Front-End Systems for Use in the System

In some embodiments, the front-end system may refer to any entity used to interact with the system. This can be divided into two parts, e.g., the hardware and the software.

### The Hardware

For the system being described, the hardware can take the form of any interface-enabled system. The device in use can range in complexity.

Desktop PC. A desktop system that may be used by one or more people, in environments such as an internet café, or a home, where the device would be generally considered “non portable”. Examples would include an Apple Desktop device, or a Tower PC.

Laptop. A device that is similar to a desktop and would produce a similar experience, but can be moved easily between locations. This device would have a variety of inputs, from a specific attached, or in-built keyboard, to a touch-screen input allowing the user to use the device more like a tablet. Examples might include a MacBook, an Alienware r18, or a Chromebook.

Betting terminal. This may be a device available to users that may be fixed in position, but does not fulfil the above qualifications, and may be accessed only through touchscreen. Although the internal hardware may be similar to a desktop PC, the interaction for the user will be through restricted access systems, such as a restricted keyboard, or a touchscreen. The user will not have full control of this device, and will be limited to applications allowed by the host of the device.

Tablet device. A tablet device can be considered any touchscreen device that does not fulfill the qualifications of a laptop or desktop, but still is not a full mobile device, as the tablet does not have mobile network communications. Examples here might be a Wi-Fi-only Samsung tablet, or a Wi-Fi-only iPad. Specifically, this device will be reliant upon a Wi-Fi network to be able to access the system.

Mobile device. This may be a full mobile network device. The mobile device may operate similar to a tablet device, insomuch as the mobile device typically uses touchscreen input, but is not always limited to this, with some devices having keyboard input as well. Identifiably, this sort of device will have independent access to a data network, as long as sufficient signal is available.

VR or AR. As technology allows, it may be possible for users to interact with the systems via either Virtual Reality, or Augmented Reality. In the first instance, via a direct viewer showing the system in question, or in the second instance, by showing the system super-imposed over a view that may already be available to the user.

### The Software

The software in use for the front end will cover any system that can be used to show the result of the system. Some examples may be as follows:

Web client. This covers any client written for use in a web environment that can be accessed through a web browser. Delivery of the content to the user could include systems such as Canvas and WebGL as part of DHTML, built using an interpreted language, such as Javascript or could include systems such as Unity that will result in the same effect.

Native App. This may be an app built for a Table, Mobile, or AR/VR device in a language such .net, using technology like Xamarin that can be delivered into app store for use by players

Native Desktop Application. This would be any application built in a native language, including items such as Java or C++ that would run locally on a desktop or laptop system and allow users to interact using their local hardware.

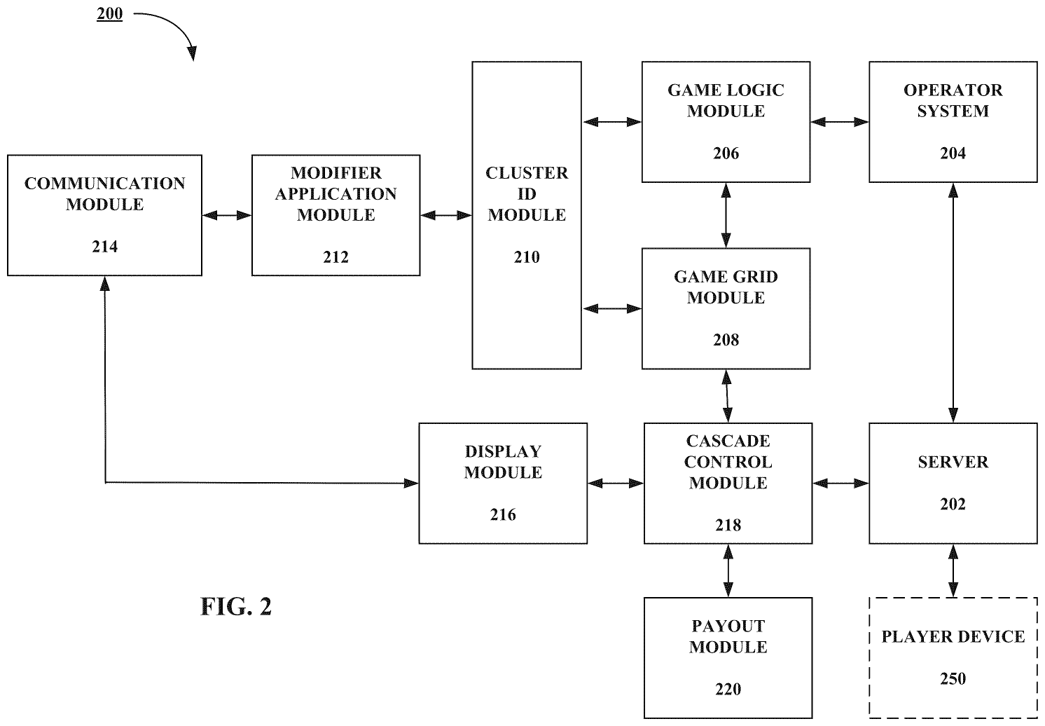

FIG. 2 is a diagram that illustrates a system 200 for conducting games, such as online casino games, designed to enhance player experience through innovative game mechanics. The system 200 includes multiple interconnected modules that work together to facilitate the game process.

The system 200 includes a server 202 configured to receive requests to initiate a round of the game. Upon receiving a request, the server 202 processes player inputs and handles the data necessary for the game. The server 202 communicates with an operator system 204 responsible for validating bets and allocating stakes. The operator system 204 ensures that bets meet the necessary criteria and allocates the appropriate stake for each bet.

Once the bet is validated, the game logic module 206 initiates. The game logic module 206 defines the game's progress and outcomes based on the player's inputs and predefined rules, which may help to ensure a fair and engaging game experience. The game grid module 208 may then load the initial game grid and randomly positions symbols within the grid. This initial setup may be used for determining potential winning combinations and interactions.

The cluster identification module 210 identifies clusters of symbols on the game grid and merges them into enhanced symbols. These enhanced symbols, e.g., SuperSymbols™, may increase in value and visual prominence, which may create a more rewarding experience for the player. The modifier application module 212 may apply various modifiers, including multipliers, to the identified enhanced symbols to further increase the identified enhanced symbols' payout value.

The communication module 214 may play a role in informing the player of the game round's outcome. The communication module 214 may communicate the result back to the client, including any winnings or losses. The display module 216 may then show the final arrangement of symbols and any resulting enhanced symbols or clusters on the player's device 250, which may provide a clear visual representation of the game results.

The cascade control module 218 may determine when an enhanced symbol forms or grows. If an enhanced symbol forms or grows, the cascade control module 218 may notify the server 202 that the client is ready for the next cascade. The cascade control module 218 may then clear the grid of non-contributing symbols and cascade in new symbols to form additional clusters and enhanced symbols, repeating the process to create more opportunities for the player to win.

The payout module 220 may be responsible for awarding final pays when no new enhanced symbols form or grow. The payout module 220 may calculate the remaining payouts based on the final state of the game grid and the predefined rules of the game, which may help ensure that the player receives the correct rewards.

It will be understood that FIG. 2 is only one example of a device or system that may implement the methods described herein. It will be understood that other devices or systems may perform one or more aspects of the methods described herein.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for conducting an online casino game, comprising:
receiving, by a server, a request to initiate a round of the game;
validating a bet and allocating a stake for the bet;
initiating game logic to define a game's progress and outcomes based on player inputs and predefined rules;
loading an initial game grid and randomly positioning symbols within the grid;
identifying clusters of symbols and merging them into an enhanced symbol, wherein the enhanced symbol increases in value and visual prominence;
applying modifiers, including multipliers, to the enhanced symbols to increase their payout value;
communicating a result of the game round to a client, including any winnings or losses;
displaying a final arrangement of symbols and any resulting enhanced symbols or clusters to the player;
determining when an enhanced symbol forms or grows and notifying the server that the client is ready for a next cascade;
clearing the grid of non-contributing symbols and cascading in new symbols to form additional clusters and enhanced symbols;
awarding final pays when no new enhanced symbols form or grow; and
completing the game round.

2. The method of claim 1, wherein the enhanced symbol is based on a pixel count of the merged symbols.

3. The method of claim 1, wherein the enhanced symbol's value is independent of a direction of the symbols within the grid.

4. The method of claim 1, wherein adjacent symbols in direct contact with the enhanced symbol can merge to increase the enhanced symbol's pixel count.

5. The method of claim 1, wherein the enhanced symbol remains on the grid after a winning cascade, and only the non-contributing symbols are removed.

6. The method of claim 1, wherein the game grid is displayed on a client device selected from the group consisting of a desktop PC, laptop, betting terminal, tablet device, mobile device, virtual reality device, and augmented reality device.

7. A system for conducting an online casino game, comprising:
a server configured to receive a request to initiate a round of the game, validate a bet, and allocate a stake for the bet;
a game logic module configured to define a game's progress and outcomes based on player inputs and predefined rules;
a game grid module configured to load an initial game grid and randomly position symbols within the grid;
a cluster identification module configured to identify clusters of symbols and merge them into an enhanced symbol;
a modifier application module configured to apply modifiers, including multipliers, to the enhanced symbols;
a communication module configured to communicate a result of the game round to a client;
a display module configured to display a final arrangement of symbols and any resulting enhanced symbols or clusters to the player;
a cascade control module configured to determine when an enhanced symbol forms or grows, notify the server that the client is ready for the next cascade, and clear the grid of non-contributing symbols; and
a payout module configured to award final pays when no new enhanced symbols form or grow.

8. The system of claim 7, wherein the enhanced symbol is based on a pixel count of the merged symbols.

9. The system of claim 7, wherein the enhanced symbol's value is independent of a direction of the symbols within the grid.

10. The system of claim 7, wherein adjacent symbols in direct contact with the enhanced symbol can merge to increase the enhanced symbol's pixel count.

11. The system of claim 7, wherein the enhanced symbol remains on the grid after a winning cascade, and only the non-contributing symbols are removed.

12. A non-transitory computer-readable medium storing instructions that, when executed by a processor, cause the processor to perform a method for conducting an online casino game, the method comprising:
receiving a request to initiate a round of the game;
validating a bet and allocating a stake for the bet;
initiating game logic to define a game's progress and outcomes based on player inputs and predefined rules;
loading an initial game grid and randomly positioning symbols within the grid;
identifying clusters of symbols and merging them into an enhanced symbol, wherein the enhanced symbol increases in value and visual prominence;
applying modifiers, including multipliers, to the enhanced symbols to increase their payout value;
communicating a result of the game round to a client, including any winnings or losses;
displaying a final arrangement of symbols and any resulting enhanced symbols or clusters to the player;
determining when an enhanced symbol forms or grows and notifying a server that the client is ready for a next cascade;
clearing the grid of non-contributing symbols and cascading in new symbols to form additional clusters and enhanced symbols;
awarding final pays when no new enhanced symbols form or grow; and
completing the game round.

13. The non-transitory computer-readable medium of claim 12, wherein the enhanced symbol is based on a pixel count of the merged symbols.

14. The non-transitory computer-readable medium of claim 12, wherein the enhanced symbol's value is independent of a direction of the symbols within the grid.

15. The non-transitory computer-readable medium of claim 12, wherein adjacent symbols in direct contact with the enhanced symbol can merge to increase the enhanced symbol's pixel count.

16. The non-transitory computer-readable medium of claim 12, wherein the enhanced symbol remains on the grid after a winning cascade, and only the non-contributing symbols are removed.

17. The non-transitory computer-readable medium of claim 12, wherein the game grid is displayed on a client device selected from the group consisting of a desktop PC, laptop, betting terminal, tablet device, mobile device, virtual reality device, and augmented reality device.
